(19) United States
(12) Patent Application Publication
(10) Pub. No.: US 2025/0226601 A1
(43) Pub. Date: Jul. 10, 2025

(54) HARDLINE CONNECTOR HAVING A METAL-REINFORCED PLASTIC MANDREL PORTION STRUCTURALLY CONFIGURED TO PREVENT MANDREL PORTION DEFORMATION

(71) Applicant: PPC BROADBAND, INC., East Syracuse, NY (US)

(72) Inventors: Henry SAUVAIN, Syracuse, NY (US); Noah MONTENA, Syracuse, NY (US)

(73) Assignee: PPC BROADBAND, INC., East Syracuse, NY (US)

(21) Appl. No.: 19/006,206

(22) Filed: Dec. 30, 2024

Related U.S. Application Data
(60) Provisional application No. 63/616,350, filed on Dec. 29, 2023.

(51) Int. Cl. H01R 9/05; H01R 13/59; H01R 13/622; H01R 13/6581; H01R 24/40; H01R 101/00

(52) U.S. Cl. CPC H01R 9/0521; H01R 9/0524; H01R 13/59; H01R 13/622; H01R 13/6581; H01R 24/40; H01R 2101/00

(57) ABSTRACT

A hardline connector may include a connector body portion, and a mandrel portion structurally configured to be positioned in the connector body portion. The mandrel portion may include a mandrel portion body portion and a mandrel portion strengthening portion, the mandrel portion body portion comprises a polymer, the mandrel portion strengthening portion may have a greater resistance to physical deformation in response to temperature than the mandrel portion body portion, and the mandrel portion body portion may include a cable receiving portion that is structurally configured to receive portions of a hardline cable. The mandrel portion body portion and the mandrel portion strength portion may be structurally configured to provide a reinforced plastic mandrel portion so as to prevent mandrel portion deformation.

### CROSS-REFERENCE TO RELATED APPLICATION

This application claims the benefit of U.S. Provisional Patent Application No. 63/616,350, filed on Dec. 29, 2023, the disclosure of which is hereby incorporated by reference herein in its entirety.

### TECHNICAL FIELD

The present disclosure is directed to a coaxial hardline connector and, more particularly, to a connector mandrel portion configured to prevent long term deformation over time.

### BACKGROUND

With greater volumes of sites, and users, engaging in digital activities that generate, transfer, and store data, the network infrastructure can be stressed for performance and/or reliability. The proliferation of wireless connectivity capabilities has expanded the number of connections needed for to be supported by main, wired trunk lines that provide robust bandwidth to devices that enable wireless communications. The combination of increased numbers of wired connections and support of wireless hardware that demand high volumes of wired bandwidth has emphasized the reliability of wired connection components, such as hardline connectors.

While hardline connectors have been utilized, in various configurations, for years, various installation and environmental stresses can result in long term deformation that jeopardizes the operation, performance, and reliability of a hardline connection. For these reasons, it is a continued goal for cable networks, particularly coaxial cable networks, to provide a hardline connector with heightened resistance to long term deformation.

Accordingly, it may be desirable to provide a hardline connector having a metal-reinforced plastic mandrel portion structurally configured to prevent mandrel portion deformation. It may be desirable to provide such a hardline connector that is structurally configured to provide adequate shielding against radio frequency (RF) interference.

### SUMMARY

In accordance with various aspects of the disclosure, a hardline connector may include a first connector body portion structurally configured to be threadedly coupled with a second connector body portion, a collet portion structurally configured to be positioned in the first connector body portion, a conductive pin portion structurally configured to disposed radially inward of the collet portion in the first connector body portion, and a mandrel portion structurally configured to be positioned in the second connector body portion. The mandrel portion may include a mandrel portion body portion and a mandrel portion strengthening portion, the mandrel portion body portion may include a polymer, and the mandrel portion strengthening portion may include a metal. The mandrel portion strengthening portion may have a greater resistance to physical deformation in response to temperature than the mandrel portion body portion, the mandrel portion body portion may include a cable receiving portion that is structurally configured to receive portions of a hardline cable, the conductive pin portion may be structurally configured to receive a center conductor of a hardline cable, and the collet portion may be structurally configured to deform a portion of the conductive pin portion in response to the first connector body portion structurally being threadedly coupled with a second connector body portion so as to cause the conductive pin portion to electrically and mechanically connect to a center conductor of a hardline cable. The polymer mandrel portion body portion and the metal mandrel portion strength portion may be structurally configured to provide a metal-reinforced plastic mandrel portion so as to prevent mandrel portion deformation.

According to some embodiments of the aforementioned connector, the strengthening portion may be configured to surround a portion of an exterior surface of the mandrel portion body portion.

According to some embodiments of the aforementioned connectors, the mandrel portion may include a longitudinal slot portion between radially spaced apart inner and outer portions of the mandrel portion body portion, and the slot portion may be structurally configured to receive at least a portion of the strengthening portion therein.

According to some embodiments of the aforementioned connectors, the mandrel portion body portion may be structurally configured to completely encapsulate the strengthening portion.

According to some embodiments of the aforementioned connectors, the metal-reinforced plastic mandrel portion may be structurally configured to resist long term plastic creep and to provide enhanced radio frequency (RF) shielding.

In accordance with various aspects of the disclosure, a hardline connector may include a connector body portion, a conductive pin portion structurally configured to disposed in the connector body portion and to receive a center conductor of a hardline cable, and a mandrel portion structurally configured to be positioned in the connector body portion. The mandrel portion may include a mandrel portion body portion and a mandrel portion strengthening portion, the mandrel portion body portion may include a polymer, the mandrel portion strengthening portion may include a metal, the mandrel portion strengthening portion may have a greater resistance to physical deformation in response to temperature than the mandrel portion body portion, and the mandrel portion body portion may include a cable receiving portion that is structurally configured to receive portions of a hardline cable. The polymer mandrel portion body portion and the metal mandrel portion strength portion may be structurally configured to provide a metal-reinforced plastic mandrel portion so as to prevent mandrel portion deformation.

According to some embodiments of the aforementioned connectors, the strengthening portion may be configured to surround a portion of an exterior surface of the mandrel portion body portion.

According to some embodiments of the aforementioned connectors, the mandrel portion may include a longitudinal slot portion between radially spaced apart inner and outer portions of the mandrel portion body portion, and the slot portion may be structurally configured to receive at least a portion of the strengthening portion therein.

According to some embodiments of the aforementioned connectors, the mandrel portion body portion may be structurally configured to completely encapsulate the strengthening portion.

According to some embodiments of the aforementioned connectors, the metal-reinforced plastic mandrel portion may be structurally configured to resist long term plastic creep and to provide enhanced radio frequency (RF) shielding.

According to some embodiments of the aforementioned connectors, the connector body portion may include a first connector body portion structurally configured to be threadedly coupled with a second connector body portion.

According to some embodiments, the aforementioned connectors may further include a collet portion structurally configured to be positioned in the first connector body portion, the conductive pin portion may be structurally configured to disposed radially inward of the collet portion in the first connector body portion, and the collet portion may be structurally configured to deform a portion of the conductive pin portion in response to the first connector body portion structurally being threadedly coupled with a second connector body portion so as to cause the conductive pin portion to electrically and mechanically connect to a center conductor of a hardline cable.

In accordance with various aspects of the disclosure, a hardline connector may include a connector body portion, and a mandrel portion structurally configured to be positioned in the connector body portion. The mandrel portion may include a mandrel portion body portion and a mandrel portion strengthening portion, the mandrel portion body portion comprises a polymer, the mandrel portion strengthening portion may have a greater resistance to physical deformation in response to temperature than the mandrel portion body portion, and the mandrel portion body portion may include a cable receiving portion that is structurally configured to receive portions of a hardline cable. The mandrel portion body portion and the mandrel portion strength portion may be structurally configured to provide a reinforced plastic mandrel portion so as to prevent mandrel portion deformation.

According to some embodiments of the aforementioned connectors, the mandrel portion strengthening portion may include a metal.

According to some embodiments of the aforementioned connectors, the strengthening portion may be configured to surround a portion of an exterior surface of the mandrel portion body portion.

According to some embodiments of the aforementioned connectors, the mandrel portion may include a longitudinal slot portion between radially spaced apart inner and outer portions of the mandrel portion body portion, and the slot portion may be structurally configured to receive at least a portion of the strengthening portion therein.

According to some embodiments of the aforementioned connectors, the mandrel portion body portion may be structurally configured to completely encapsulate the strengthening portion.

According to some embodiments of the aforementioned connectors, the reinforced plastic mandrel portion may be structurally configured to resist long term plastic creep and to provide enhanced radio frequency (RF) shielding.

According to some embodiments of the aforementioned connectors, the connector body portion may include a first connector body portion structurally configured to be threadedly coupled with a second connector body portion.

According to some embodiments, the aforementioned connectors may further include a collet portion structurally configured to be positioned in the first connector body portion, and a conductive pin portion structurally configured to receive a center conductor of a hardline cable. The conductive pin portion may be structurally configured to disposed radially inward of the collet portion in the first connector body portion, and the collet portion may be structurally configured to deform a portion of the conductive pin portion in response to the first connector body portion structurally being threadedly coupled with a second connector body portion so as to cause the conductive pin portion to electrically and mechanically connect to a center conductor of a hardline cable.

### BRIEF DESCRIPTION OF THE DRAWINGS

Further advantages and features of the present disclosure will become apparent from the following description and the accompanying drawings, to which reference is made.

FIG. 1 is a line representation of portions of a cable network in which assorted embodiments can be practiced.

FIG. 2 is a line representation of portions of a cable assembly that can be employed in the network of FIG. 1 in various embodiments.

FIG. 3 is a cross-sectional view of portions of a hardline connector that can be utilized in the network of FIG. 1 and the assembly of FIG. 2 in accordance with some embodiments.

FIG. 4 is a perspective view a mandrel portion configured in accordance with various embodiments to be incorporated in the hardline connector of FIG. 3.

FIG. 5 is a cross-sectional view of a mandrel portion configured in accordance with some embodiments to be incorporated in the hardline connector of FIG. 3.

FIG. 6 is perspective exploded view of a hardline connector utilizing a mandrel portion constructed and operated in accordance with various embodiments.

### DETAILED DESCRIPTION

Embodiments provide a connector having a mandrel portion that provides both metal and plastic aspects to optimize the physical and electrical translation of a cable conductor to a conductor pin to reduce, or eliminate, noise.

Reference will now be made in detail to presently preferred embodiments and methods of the present disclosure, which constitute the best modes of practicing the present disclosure presently known to the inventors. However, it is to be understood that the disclosed embodiments are merely exemplary of the present disclosure that may be embodied in various and alternative forms. Therefore, specific details disclosed herein are not to be interpreted as limiting, but merely as a representative basis for any aspect of the present disclosure and/or as a representative basis for teaching one skilled in the art to variously employ the present disclosure.

It is also to be understood that this present disclosure is not limited to the specific embodiments and methods described below, as specific components and/or conditions may, of course, vary. Furthermore, the terminology used herein is used only for the purpose of describing particular embodiments of the present disclosure and is not intended to be limiting in any way.

While wired cabling can be quite reliably to provide signal pathways that can result in two-way communication, the physical connection of wired cables can introduce difficulties in installation and operation over time. The use of a hardline connector as part of a wired cable network can translate a cable into an interface that can efficiently interact with a network component, such as a port. However, a hardline connector can rely on the proper installation and operation of a mandrel portion to effectively translate a cable into a desired interface. Accordingly, various embodiments are generally directed to increasing the resistance of a hardline connector mandrel portion to long term deformation to reduce the variability of connector installation and operation over time.

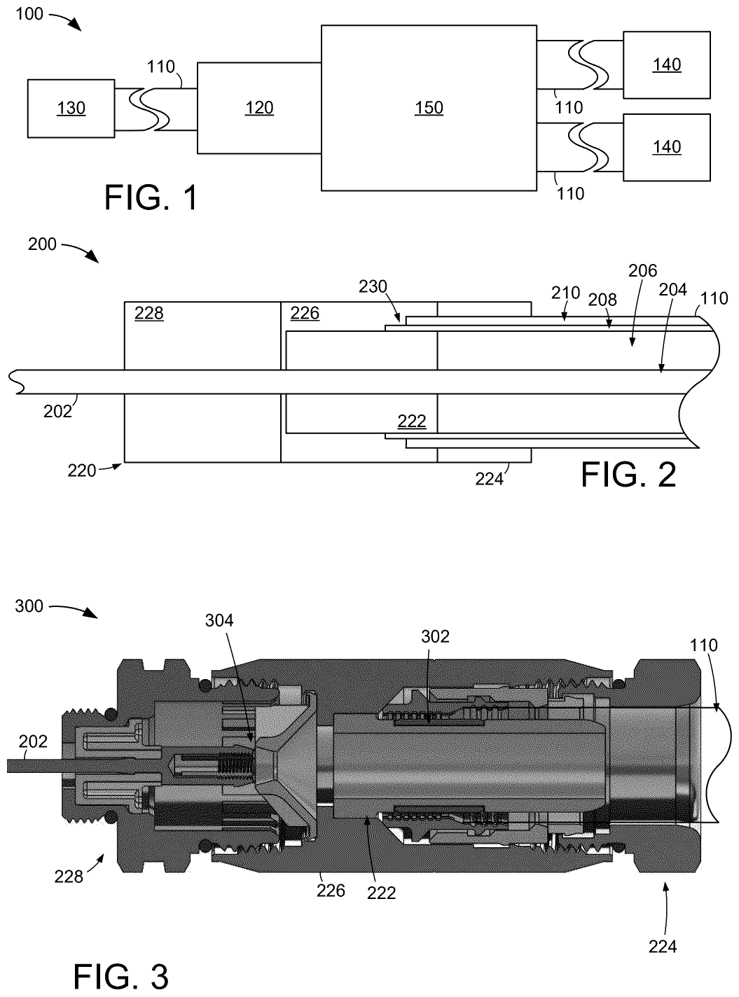

FIGS. 1 and 2 respectively depict aspects of a cable network 100 that can employ assorted aspects of a mandrel portion to increase performance and reliability by mitigating the risk of long term physical deformation, which can be characterized as creep. In FIG. 1, a line representation of portions of a cable network 100 is illustrated that can utilize a hardline connector in accordance with various embodiments. The cable network 100 can extend to any number of sites with one or more signal carrying cables 110 that employ at least one interconnect 120 to provide a continuous signal pathway from a signal source 130 to a signal destination 140.

The non-limiting embodiment shown in FIG. 1 conveys how an interconnect 120 can join a cable 110 to a network component 150, such as a server, switch, distribution box, or computing device. The interconnect 120, in some embodiments, provides an interface that can efficiently, and securely, engage a port of the network component 150. For instance, the interconnect 120 can be a hardline connector that translates a signal conductor into a conductive pin portion that physically engages a component port, such as a female F-type connector port, to establish at least one electrical connection and signal pathway to the component 150.

It is contemplated that the cable network 100 can employ any number, type, and length of cable 110 that provide a reliable signal pathway. For instance, a coaxial-type cable 110 can be employed that utilizes an electrical conductor while another cable 110 can be a fiber optic-type signal pathway. The ability to employ one or more interconnects 120 allows the cable network 100 to effectively utilize a diverse range of cables 110 with matching, or dissimilar, characteristics and/or capabilities to provide a unitary network 100 that supplies one or more stable and continuous signal pathways between source(s) 130 and destination(s) 140.

FIG. 2 illustrates a line representation of portions of a cable assembly 200 that can be utilized as part of the cable network 100 of FIG. 1. The assembly 200 translates a signal cable 110 into a conductive pin portion 202 that can engage a port of a device, an adapter, or other interconnect interface to establish and maintain a signal pathway from the cable conductor, for example, a center conductor 204. It is contemplated, but not required, that the cable 110 is constructed with one or more signal conductors 204 surrounded by at least one insulating layers 206. The cable 110 can employ one or more shielding layers 208 to provide physical, electrical, and/or magnetic protection to the constituent conductor(s) 204 of the cable 110. At least one outer cable jacket 210 may further provide structural protection for the cable conductor(s) 204.

While the cable conductor(s) 204 can be physically and electrically connected to the conductive pin portion 202 in a variety of interfaces and/or adapters, various embodiments secure the connection with a hardline connector 220 that houses a mandrel portion 222 that provides structural and electrical considerations that allow the conductive pin portion 202 to conduct a signal from the cable conductor 204. That is, the mandrel portion 222 is configured to provide structural and electrical translation of the cable conductor(s) 204 to the conductive pin portion 202 without introducing interference or physical weakness. The hardline connector 220 may further be configured with a cap portion 224, a body portion 226, and a pin portion 228 that collectively secure the cable 110, mandrel portion 222, and pin 202 in position to maintain reliable electrical connection between the conductor(s) 204 and the pin 202.

The mandrel portion 222 can provide a rigid coupler that the shielding layer 208 attaches to while the conductor(s) 204 and insulating layer 206 are positioned inside mandrel portion 222. As shown in the cross-sectional view of FIG. 3, the mandrel portion 222 may be a hollow member that has a varying exterior topography to aid in engagement and clamping of the shielding layer 208 and outer jacket 210. Returning to FIG. 2, portions of the outer jacket 210 can be stripped, as shown by region 230, to allow the shielding layer 208 to securely attach to the mandrel portion 222 and provide desired performance, such as electrical grounding, magnetic interference blocking, and/or radio frequency interference (or RFI) shielding.

Construction of the mandrel portion 222 can provide installation and operational challenges along with benefits. For instance, constructing the mandrel portion 222 entirely of one or more metal materials, such as aluminum, brass, or copper, can preserve signal strength in the conductor 204 while being physically resilient to deformation during installation as well as in response to environmental stresses over time. However, metal mandrel portions 222 can have capacitance and other electrical conditions that introduce noise into the signals transmitted through the conductor 204 and pin 202.

With these reasons in mind, a mandrel portion 222 may, alternatively, be constructed completely of one or more polymer materials. A plastic mandrel portion 222 can provide a lower cost and improved electrical performance compared to a metal material by providing a shorter electrical path to ground inside the connector 200. However, strength of a plastic mandrel portion 222 can be limited and require thicker sidewalls, which can degrade shielding of some frequencies, such as radio frequencies, along with degradation of conductor 204 signal strength. Regardless of the thickness of a polymer mandrel portion 222, physical creep can occur over time in response to temperature, applied force, or both. Hence, a mandrel portion 222 is configured in accordance with some embodiments to have long term deformation resistance without degrading shielding or signal strength through the connector 200.

In FIG. 3, the mandrel portion 222 is illustrated as assembled in a connector 300 with portions of the cable 110 clamped onto the mandrel portion 222 by the engagement of the cap portion 224 with the body portion 226. The mandrel portion 222 is configured with a metal ring portion 302 that surrounds the exterior of less than all the longitudinal length of the mandrel portion 222. By supplementing portions of the plastic mandrel portion 222 with the metal ring portion 302, resistance to long term deformation can be increased while the shielding performance and signal strength integrity of the mandrel portion 222 can be optimized without degrading electrical performance. That is, the structural integrity of the ring portion 302, particularly during temperature cycling, can supplement the plastic mandrel portion 222 to prevent long term deformation without causing electrical or signal degradation.

The addition of the metal ring portion 302 does not impede the ability of the mandrel portion 222 to align with, and secure an electrical connection through a collet 304 to the conductive pin portion 202. In contrast, physically enlarging aspects of the mandrel portion 222 to prevent long term deformation may make alignment and/or electrical connection with the collet portion 304 and conductive pin portion 202. It is noted that the addition of the metal material may provide a balanced compromise of increased deformation resistance and physical strength with electrical and shielding performance. Accordingly, various embodiments are directed to a hardline connector mandrel portion 222 that provides both metal and plastic aspects to optimize the physical and electrical translation of the cable conductor 204 to the conductor pin 202.

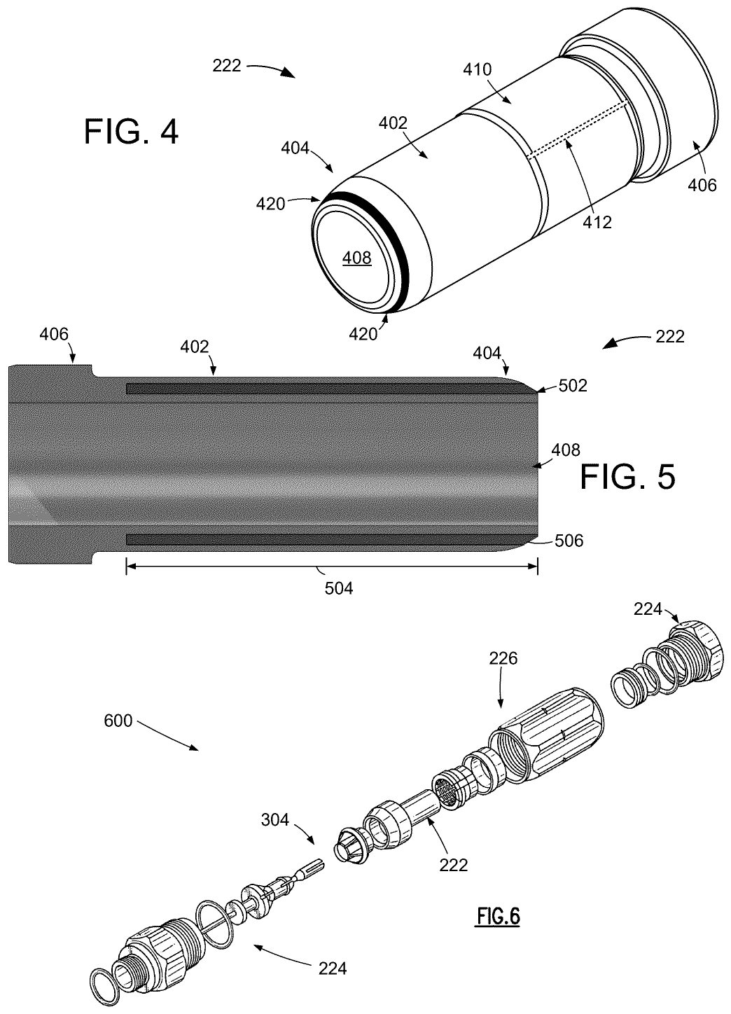

FIG. 4 illustrates a perspective line view of portions of a mandrel portion 222 arranged in accordance with various embodiments to be able to operate in the connector 300 of FIG. 3, the cable assembly 200 of FIG. 2, and the cable network 100 of FIG. 1. The mandrel portion 222 has a body portion 402, for example, a unitary body portion, with a tapered first end portion 404 and a raised second end portion 406. A metal portion 410, for example, a metal ring or metal band, extends around the external periphery of the body portion 402 without obscuring any portion of the conductor aperture 408 that continuously extends along the length of the mandrel portion 222 parallel to the longitudinal axis of the body portion 402.

The metal portion 410 can be constructed in a variety of different configurations and materials. Some embodiments arrange the metal portion 410 of aluminum with a uniform thickness while other embodiments provide a varying, or textured, thickness, which can provide customized structural, shielding, and/or electrical performance once installed in a hardline connector, such as connector 300. It is contemplated that portions of the metal portion 410 are coated to provide various physical performance, such as increased friction, cooling, and/or temperature uniformity in the mandrel portion 222.

The metal portion 410 may, in various embodiments, be arranged as a discontinuous ring, which can be defined as a gap portion 412 in the metal material. By including the gap portion 412 and making the metal portion 410 discontinuous, installation of the metal portion 410 can be more consistent than a continuous metal portion 410 due to a more uniform response to applied clamping force. The presence of the gap portion 412 further allows the mandrel portion 222 to maintain physical position and engagement with a cable 110 over time by accommodating changes in experienced force and/or temperature.

The combination of a completely polymer mandrel portion body portion 402 with the metal portion 410 can provide heightened shielding and electrical performance compared to a purely plastic or purely metal mandrel portion construction. For clarity, a mandrel portion 222 constructed solely of metal materials has high tolerance to inadvertent physical deformation under varying pressure and/or temperatures, but can induce electrical performance degradation. A mandrel portion 222 constructed solely of polymer materials have increased electrical and shielding performance compared to a metal mandrel portion 222, but experience physical deformation over time, particularly in response to varying pressure and/or temperature cycling. Hence, embodiments of a mandrel portion 222 incorporate metal material into a polymer mandrel portion body portion 402 to provide optimal connector performance over time by mitigating physical deformation due to force and temperature.

It is noted that the integration of metal material into the mandrel portion 222 is not limited to a particular configuration. Some embodiments utilize the continuous metal portion 410 that fits atop the body portion 402. It is contemplated that the metal portion 410 fits, partially or wholly, in a groove in the external surface of the mandrel portion 222, but such arrangement is not required. Assorted embodiments configure the metal portion 410 to be discontinuous, as illustrated in FIG. 4 by segmented gap region 412. Meanwhile, other embodiments may integrate a metal material into the mandrel portion 222, as shown by an internal metal portion 420, for example a metal band or metal ring, so that minimal metal material is exposed to the external surface of the mandrel portion 222 or the interior surface of the conductor aperture 408. It should be understood that

The cross-sectional view of FIG. 5 illustrates a mandrel portion 222 that incorporates metal material in accordance with various embodiments. The mandrel portion 222 has a slot portion 502 extending parallel to the longitudinal axis of the mandrel portion 222 for a selected length 504. The slot portion 502 is occupied by a metal portion 506, for example, a metal band or a metal ring, that serves to increase the deformation resistance of the mandrel portion 222. The arrangement of the slot portion 502 can allow for selective utilization. For instance, different rings 506 can be selectively inserted into the slot portion 502 to provide different materials and/or locations for metal support. The ability to remove and insert one or more rings 506 into the slot portion 502 allows for customization of the presence of metal in the mandrel portion 222, which can provide optimized balance of electrical/shielding performance with deformation mitigation.

While exposing the slot portion 502 to the exterior of the mandrel portion 222, as shown in FIG. 5, allows for access and different metal portion 506 arrangements, various embodiments incorporate metal material without such exterior access. For instance, metal material can be overmolded into one or more locations of the mandrel portion 222, which can be characterized as no portion of metal material being exposed to the exterior surface of the mandrel portion 222 or to the conductor aperture 408. The capability to incorporate metal into a mandrel portion 222 in multiple different manners, such as the externally positioned metal portion 410, accessible internal metal portion 506, or overmolded metal region, provides a diverse array of structural and performance configurations that can cater the mandrel portion size, electrical operation, and shielding operation while mitigating the risk of physical deformation over time.

FIG. 6 illustrates an exploded view of a connector 600 that can employ a mandrel portion 222 as part of a cable assembly, such as assembly 200 of FIG. 2. The exploded view of connector 600 conveys how the cap portion, a body portion, and a pin portion can respectively include multiple components that aid in the alignment, engagement, electrical connection, shielding, and/or waterproofing. It is noted that the assorted portions are shown in FIG. 6 as separated assemblies, but such configuration is not required as any component can be removed, modified, or moved without departing from the spirit of the present disclosure.

Also, with respect to the various embodiments of the present disclosure, the components of the cable 110 can be constructed of various materials which have some degree of elasticity or flexibility. The elasticity enables the cable 110 to flex or bend in accordance with broadband communications standards, installation methods or installation equipment. Also, the radial thicknesses of the cable 110, the signal pathway conductor 130, insulator 140, any shielding layers 150, and the outer jacket 160 can vary based upon parameters corresponding to broadband communication standards or installation equipment.

Additional embodiments include any one of the embodiments described above, where one or more of its components, functionalities or structures is interchanged with, replaced by or augmented by one or more of the components, functionalities or structures of a different embodiment described above. It should be understood that various changes and modifications to the embodiments described herein will be apparent to those skilled in the art. Such changes and modifications can be made without departing from the spirit and scope of the present disclosure and without diminishing its intended advantages. It is therefore intended that such changes and modifications be covered by the appended claims.

Although several embodiments of the disclosure have been disclosed in the foregoing specification, it is understood by those skilled in the art that many modifications and other embodiments of the disclosure will come to mind to which the disclosure pertains, having the benefit of the teaching presented in the foregoing description and associated drawings. It is thus understood that the disclosure is not limited to the specific embodiments disclosed herein above, and that many modifications and other embodiments are intended to be included within the scope of the appended claims. Moreover, although specific terms are employed herein, as well as in the claims which follow, they are used only in a generic and descriptive sense, and not for the purposes of limiting the present disclosure, nor the claims which follow.

What is claimed is:

1. A hardline connector structurally configured to prevent mandrel portion deformation, comprising:
a first connector body portion structurally configured to be threadedly coupled with a second connector body portion;
a collet portion structurally configured to be positioned in the first connector body portion;
a conductive pin portion structurally configured to disposed radially inward of the collet portion in the first connector body portion;
a mandrel portion structurally configured to be positioned in the second connector body portion;
wherein the mandrel portion comprises a mandrel portion body portion and a mandrel portion strengthening portion;
wherein the mandrel portion body portion comprises a polymer;
wherein the mandrel portion strengthening portion comprises a metal;
wherein the mandrel portion strengthening portion has a greater resistance to physical deformation in response to temperature than the mandrel portion body portion;
wherein the mandrel portion body portion comprises a cable receiving portion that is structurally configured to receive portions of a hardline cable;
wherein the conductive pin portion is structurally configured to receive a center conductor of a hardline cable;
wherein the collet portion is structurally configured to deform a portion of the conductive pin portion in response to the first connector body portion structurally being threadedly coupled with a second connector body portion so as to cause the conductive pin portion to electrically and mechanically connect to a center conductor of a hardline cable; and
wherein the polymer mandrel portion body portion and the metal mandrel portion strength portion are structurally configured to provide a metal-reinforced plastic mandrel portion so as to prevent mandrel portion deformation.

2. The connector of claim 1, wherein the strengthening portion is configured to surround a portion of an exterior surface of the mandrel portion body portion.

3. The connector of claim 1, wherein the mandrel portion comprises a longitudinal slot portion between radially spaced apart inner and outer portions of the mandrel portion body portion; and
wherein the slot portion is structurally configured to receive at least a portion of the strengthening portion therein.

4. The connector of claim 1, wherein the mandrel portion body portion is structurally configured to completely encapsulate the strengthening portion.

5. The connector of claim 1, wherein the metal-reinforced plastic mandrel portion is structurally configured to resist long term plastic creep and to provide enhanced radio frequency (RF) shielding.

6. A hardline connector structurally configured to prevent mandrel portion deformation, comprising:
a connector body portion;
a conductive pin portion structurally configured to disposed in the connector body portion and to receive a center conductor of a hardline cable;
a mandrel portion structurally configured to be positioned in the connector body portion;
wherein the mandrel portion comprises a mandrel portion body portion and a mandrel portion strengthening portion;
wherein the mandrel portion body portion comprises a polymer;
wherein the mandrel portion strengthening portion comprises a metal;
wherein the mandrel portion strengthening portion has a greater resistance to physical deformation in response to temperature than the mandrel portion body portion;
wherein the mandrel portion body portion comprises a cable receiving portion that is structurally configured to receive portions of a hardline cable; and
wherein the polymer mandrel portion body portion and the metal mandrel portion strength portion are structurally configured to provide a metal-reinforced plastic mandrel portion so as to prevent mandrel portion deformation.

7. The connector of claim 6, wherein the strengthening portion is configured to surround a portion of an exterior surface of the mandrel portion body portion.

8. The connector of claim 6, wherein the mandrel portion comprises a longitudinal slot portion between radially spaced apart inner and outer portions of the mandrel portion body portion; and
wherein the slot portion is structurally configured to receive at least a portion of the strengthening portion therein.

9. The connector of claim 6, wherein the mandrel portion body portion is structurally configured to completely encapsulate the strengthening portion.

10. The connector of claim 6, wherein the metal-reinforced plastic mandrel portion is structurally configured to resist long term plastic creep and to provide enhanced radio frequency (RF) shielding.

11. The connector of claim 6, wherein the connector body portion comprises a first connector body portion structurally configured to be threadedly coupled with a second connector body portion.

12. The connector of claim 11, further comprising a collet portion structurally configured to be positioned in the first connector body portion;
wherein the conductive pin portion is structurally configured to disposed radially inward of the collet portion in the first connector body portion; and
wherein the collet portion is structurally configured to deform a portion of the conductive pin portion in response to the first connector body portion structurally being threadedly coupled with a second connector body portion so as to cause the conductive pin portion to electrically and mechanically connect to a center conductor of a hardline cable.

13. A hardline connector structurally configured to prevent mandrel portion deformation, comprising:
a connector body portion;
a mandrel portion structurally configured to be positioned in the connector body portion;
wherein the mandrel portion comprises a mandrel portion body portion and a mandrel portion strengthening portion;
wherein the mandrel portion body portion comprises a polymer;
wherein the mandrel portion strengthening portion has a greater resistance to physical deformation in response to temperature than the mandrel portion body portion;
wherein the mandrel portion body portion comprises a cable receiving portion that is structurally configured to receive portions of a hardline cable; and
wherein the mandrel portion body portion and the mandrel portion strength portion are structurally configured to provide a reinforced plastic mandrel portion so as to prevent mandrel portion deformation.

14. The connector of claim 13, wherein the mandrel portion strengthening portion comprises a metal.

15. The connector of claim 13, wherein the strengthening portion is configured to surround a portion of an exterior surface of the mandrel portion body portion.

16. The connector of claim 13, wherein the mandrel portion comprises a longitudinal slot portion between radially spaced apart inner and outer portions of the mandrel portion body portion; and
wherein the slot portion is structurally configured to receive at least a portion of the strengthening portion therein.

17. The connector of claim 13, wherein the mandrel portion body portion is structurally configured to completely encapsulate the strengthening portion.

18. The connector of claim 13, wherein the reinforced plastic mandrel portion is structurally configured to resist long term plastic creep and to provide enhanced radio frequency (RF) shielding.

19. The connector of claim 13, wherein the connector body portion comprises a first connector body portion structurally configured to be threadedly coupled with a second connector body portion.

20. The connector of claim 19, further comprising:
a collet portion structurally configured to be positioned in the first connector body portion;
a conductive pin portion structurally configured to receive a center conductor of a hardline cable;
wherein the conductive pin portion is structurally configured to disposed radially inward of the collet portion in the first connector body portion; and
wherein the collet portion is structurally configured to deform a portion of the conductive pin portion in response to the first connector body portion structurally being threadedly coupled with a second connector body portion so as to cause the conductive pin portion to electrically and mechanically connect to a center conductor of a hardline cable.
